(19) United States
(12) Patent Application Publication
(10) Pub. No.: US 2007/0284779 A1
(43) Pub. Date: Dec. 13, 2007

(54) Imprint lithography apparatus and methods

(76) Inventors: Wei Wu, Palo Alto, CA (US); Shih-Yuan Wang, Palo Alto, CA (US); Zhaoning Yu, Palo Alto, CA (US); R. Stanley Williams, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/451,993

(22) Filed: Jun. 13, 2006

(51) Int. Cl. B29C 35/08; B29C 59/00

(52) U.S. Cl. 264/293; 425/385; 425/174.4; 101/3.1; 101/32; 264/496

(57) ABSTRACT

An apparatus for forming a pattern in a curable material carried on a substrate having one or more components with coefficients of thermal expansion that are substantially equal to the coefficient of thermal expansion of the substrate.

### BACKGROUND OF THE INVENTIONS

Imprint lithography processes are capable of forming structures that are 100 nanometers or less in size and have been used to manufacture devices that include, but are not limited to, microelectronic devices (e.g. integrated circuits), magnetic storage devices, mechanical systems, micro-electro-mechanical systems, optical devices and biological testing devices. Imprint lithography involves the formation of a relief pattern in material that is carried on the surface of a substrate. More specifically, in one type of imprint lithography process, a template with a relief pattern (or “mold”) is brought into contact with a material on a substrate that is in liquid form at room temperature, or that is liquefied by heating. The liquid material fills the template and assumes the shape of the relief pattern. The material is then subjected to conditions that cause the material to solidify and the template is removed. A structure (or “layer”) in the shape of the relief pattern will then remain on the substrate. This process may be repeated on different portions of the substrate with the same template in what is referred to as a step and repeat process. This process may also be repeated on the same portion(s) of the substrate with the same or different templates to form multi-layer structures. Etching may be used to remove portions of the patterned material in some or all of the layers.

Although imprint lithography apparatus and methods have proven to be quite useful, especially in the area nanometer-sized structures, the present inventors have determined that they are susceptible to improvement. For example, the present inventors have determined that the imprint lithography apparatus and methods available heretofore are susceptible to improvement in the area of substrate and template alignment.

### BRIEF DESCRIPTION OF THE DRAWINGS

Detailed description of embodiments of the inventions will be made with reference to the accompanying drawings.

FIG. 1 is a front, partial section view of an imprint lithography system in accordance with one embodiment of a present invention.

FIG. 2 is a front view of an imprint lithography apparatus in accordance with one embodiment of a present invention.

FIGS. 3-6 are views of a patterned layer being formed on a substrate.

FIG. 7 is a plan view of an exemplary substrate.

FIG. 8 is a rear view of an exemplary patterned template.

FIG. 8A is a plan view of an exemplary substrate.

FIG. 9 is a flow chart of a method in accordance with one embodiment of a present invention.

### DETAILED DESCRIPTION OF THE EMBODIMENTS

The following is a detailed description of the best presently known modes of carrying out the inventions. This description is not to be taken in a limiting sense, but is made merely for the purpose of illustrating the general principles of the inventions. It is noted that detailed discussions of aspects of imprint lithography systems and methods that are not required for the understanding of the present inventions, such as the specific characteristics of the imprint head, motion stage and control systems, have been omitted for the sake of simplicity. The present inventions are also applicable to a wide range of imprint lithography systems and methods, including those presently being developed or yet to be developed. For example, although the present inventions are primarily described below in the context of UV-curable imprint lithography, the present inventions are also applicable to thermal imprint lithography.

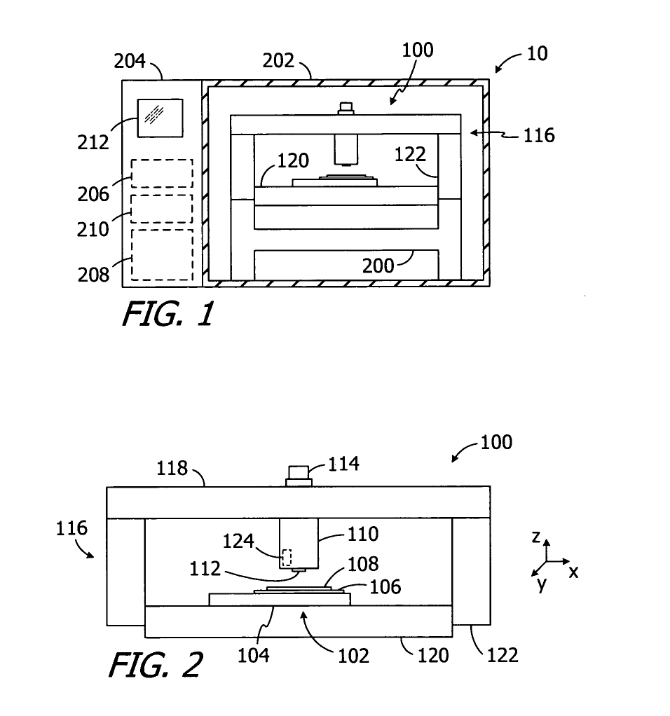

One example of an imprint lithography system in accordance with a present invention is generally represented by reference numeral 10 in FIG. 1. The exemplary system 10 includes an imprint lithography apparatus 100 that is mounted on a support table 200 within a temperature controlled apparatus enclosure 202. An electronics enclosure 204 houses a system controller 206, a temperature control apparatus 208, which maintains the interior of the apparatus enclosure 202 at the desired temperature, a power supply 210 and a user interface 212. Specific examples of imprint lithography systems that may be modified so as to embody the present inventions include the Imprio® imprint lithography systems available from Molecular Imprints, Inc. in Austin, Tex.

Turning to FIG. 2, the exemplary imprint lithography apparatus 100 includes a motion stage 102, which has a base 104 and substrate chuck 106 that holds a substrate 108 and moves relative to the base, an imprint head 110 that carries a patterned template 112 and a radiation source 114, and a support apparatus 116 that mechanically connects the motion stage to the imprint head. In the illustrated embodiment, the support apparatus 116 includes a bridge 118 on which the imprint head 110 is supported, a motion stage support 120 and a pair of bridge supports 122 that connect the bridge to the motion stage support. The motion stage chuck 106 in the illustrated embodiment moves in the x and y-directions, and the imprint head 110 moves in the z-direction. Alternatively, the motion stage chuck 106 and imprint head 110 may be respectively configured to move in any one, any two, all three or none of the x, y, and z-directions. A liquid dispenser head 124, which is connected to a source of curable liquid (not shown), is carried within the imprint head 110 in the illustrated embodiment and used to deposit curable liquid onto the substrate 108. Alternatively, the curable liquid may be spin coated onto the substrate 108 on the imprint lithography apparatus itself, or on a separate machine.

Although the present inventions are not limited to any particular curable liquids, suitable curable liquids include, for example, low viscosity light curable monomer liquids. A monomer and photoinitiator combination, such as those found in commercially available UV curable imprint resist, is one example thereof. The configuration of the radiation source 114 depends on the type of curable liquids that will be employed. If, for example, the curable liquids are UV curable liquids, then the radiation source 114 will be configured to emit UV radiation, as it is in the illustrated embodiment.

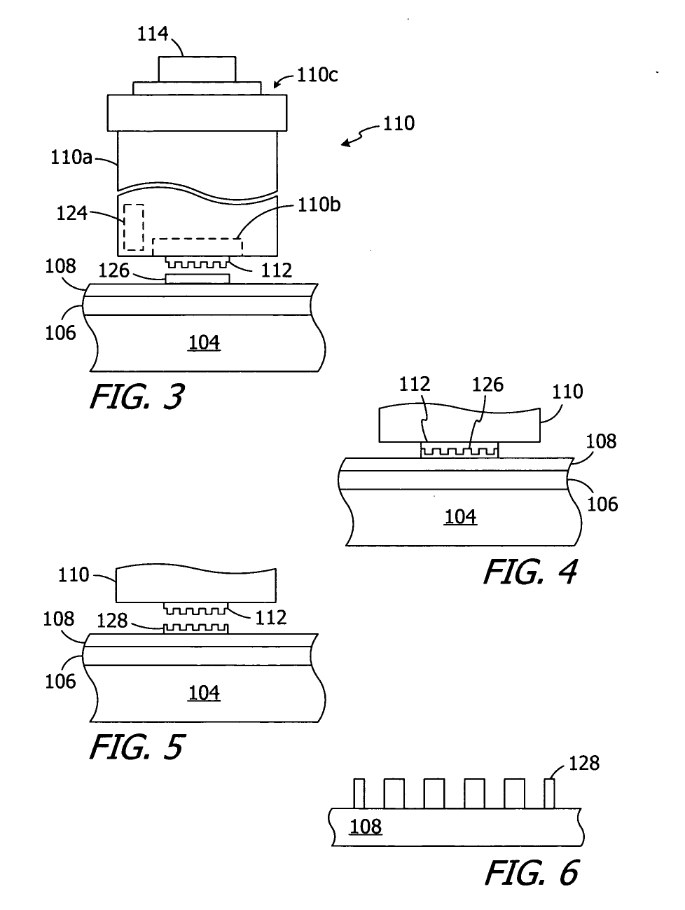

Generally speaking, an exemplary imprint process proceeds in the manner illustrated in FIGS. 3-6. A volume of curable liquid 126 is deposited onto the substrate 108. The volume of curable liquid 126 may be a continuous film, as shown, or a plurality of adjacent beads. In either case, the patterned template 112 and curable liquid 126 are then brought into alignment with one another (FIG. 3) and, thereafter, into contact with the one another (FIG. 4). The curable liquid 126, which will conform to the shape of the patterned template 112, may be cured by activating the radiation source 114. The radiation source 114 directs UV radiation through the patterned template 112 and into the curable liquid 126 until the liquid is solidified. The patterned template 112 is then removed (FIG. 5). The result is a solid layer 128 with a pattern that is complementary to the patterned template 112. Portions of the patterned solid layer 128 may be removed (FIG. 6) by etching or other suitable processes and/or additional patterned solid layers may be formed over the patterned solid layer 128. The steps illustrated in FIGS. 2-5 may also be repeated on a plurality of regions of the substrate 108 in a “step and repeat” process.

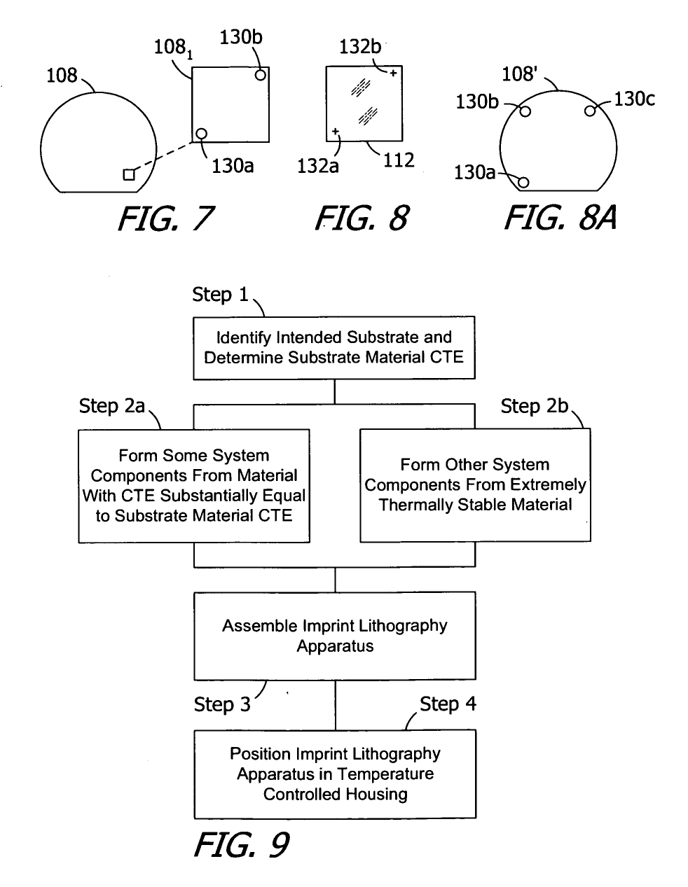

One important aspect of any imprint lithography process is the alignment of the substrate 108 relative to the patterned template 112. Correct alignment of the substrate 108 and the patterned template 112 is necessary in order to locate the patterned layer on the intended region of the substrate and to achieve proper alignment of a patterned layer with any previously formed patterned layers. Accordingly, and referring to FIGS. 7 and 8, the exemplary imprint lithography system 10 defines a plurality of substrate regions 108₁₋ₓ on the substrate 108 where the pattern associated with the patterned template 112 will be recorded. Each substrate region 108₁₋ₓ includes a pair of fiducial reference marks 130a and 130b in, for example, the form of an “o” at opposing corners the region. The exemplary template 112 has a corresponding pair of alignment marks 132a and 132b in, for example, the form of a “+” at opposing corners of the template. Machine vision apparatus (not shown) may be used to determine when the template 112 is aligned with a particular substrate region 108₁₋ₓ, as evidenced by the alignment marks 132a and 132b on the template being superimposed within the fiducial reference marks 130a and 130b associated with that substrate region.

It should be noted that the above-described alignment method, which is commonly used in step and repeat processes, is merely one exemplary alignment method and that the present inventions are not limited to any particular alignment method. For example, as illustrated in FIG. 8A, a substrate 108′ includes three fiducial reference marks 130a-c that are used to align the entire substrate, as opposed to a particular substrate region, with a template. This type of alignment may be used in whole wafer imprint processes.

The present inventors have determined that slight variations in temperature can result in misalignment between the substrate and the template. More specifically, the present inventors have determined that differences in the thermal coefficient of expansion (“CTE”) between the substrate and components of the imprint lithography system, combined with temperature variation, can lead to misalignment. Differences in the respective CTEs of the substrate and components of imprint lithography system may, for example, result in situations where the template will properly align with the substrate regions at a “base” temperature (e.g. 21° C.), but will not properly align with the substrate regions at another temperature (e.g. 22° C.) because the substrate and the imprint lithography system components will expand at different rates. Temperature decreases have essentially the same undesirable effect because the substrate and imprint lithography system components will shrink at different rates. Such situations arise because it can be quite difficult to perfectly maintain the temperature within, for example, the apparatus enclosure 202 illustrated in FIG. 1 as multiple patterned layers are formed one on top of the other. It should also be emphasized here that, in the context of structures that are as small as a few nanometers in size, small changes in the relative sizes of the substrate and the imprint lithography system components can have a profound effect on the overall accuracy of the process.

The present inventors have determined that the temperature related misalignment issues described in the preceding paragraph may be substantially eliminated by selecting materials used for some or all of the components of imprint lithography system, or at least the structurally significant portions of some or all of the imprint lithography system components, from materials with CTEs that are substantially equal to the CTE of the substrate that the system is intended to form patterned layers on. In one implementation, the CTEs are chosen with respect to a predetermined base temperature because CTEs vary with temperature and these variations differ from one material to another. For example, the substrate and imprint lithography system materials may have CTEs that are substantially equal to one another at a base temperature of 21° C. As used herein, CTEs that are substantially equal to one another are CTEs that will allow the substrate and imprint lithography system components to expand and contract with one another in such a manner that expected variations from the base temperature will result misalignments of no more than about 100 nanometers/cm of substrate in the X and/or Y directions. In the exemplary context of UV curable imprint lithography on the silicon or gallium arsenide substrates discussed below, where the expected temperature variation from the base temperature is about 1-2° C., CTEs that are within about 1×10⁻⁶/° C. of each other at the base temperature (e.g. 21° C.) are “substantially equal.” Alternatively, in the exemplary context of thermal imprint lithography on the silicon or gallium arsenide substrates discussed below, where the expected temperature variation from the base temperature is up to about 150° C., CTEs that are within about 0.1×10⁻⁶/° C. of each other at the base temperature (e.g. 21° C.) are “substantially equal.”

With respect to the exemplary substrate 108, suitable substrate materials include, but are not limited to, silicon (CTE at 21° C. equal to 2.6×10⁻⁶/° C.) and gallium arsenide (CTE at 21° C. equal to 5.7×10⁻⁶/° C.). A release layer or other film may, in some instances, be provided on the top surface of the substrate 108 or on the surface of the template 112. Such films are typically extremely thin and will not affect the CTE of the underlying substrate 108.

Turning to the imprint lithography system, and when the intended substrate 108 is a silicon substrate, one example of a suitable material for the motion stage 102, imprint head 110 and support apparatus 116 of the apparatus 100, or at least the structurally significant portions thereof, is the iron-nickel alloy FeNi42. The CTE of FeNi42 at 21° C. is typically equal to 2.6×10⁻⁶/° C. The CTE of FeNi42, as well as the CTEs of the iron-nickel alloys discussed below, can be adjusted by adjusting the percentage of Ni in the alloy. In those instances where the intended substrate 108 is a gallium arsenide substrate, a suitable material for the motion stage 102, imprint head 110 and support apparatus 116, or at least the structurally significant portions thereof, is FeNi46. The CTE of FeNi46 at 21° C. is typically equal to 5.7×10⁻⁶/° C. In those instances where the substrate is glass (e.g. an alkali borosilicate glass with a CTE equal to about 5.2×10⁻⁶/° C. at 21° C.), a suitable material for the motion stage 102, imprint head 110 and support apparatus 116, or at least the structurally significant portions thereof, is an iron-nickel-cobalt alloy commonly sold under the tradename Kovar®. The CTE of Kovar® at 21° C. is typically equal to 5.5×10⁻⁶/° C.

Although the present inventions are not limited to any particular type of motion stage, the exemplary motion stage 102 includes a number of components, some of which may be considered structurally significant. As noted above, the exemplary motion stage 102 includes a base 104 and a substrate chuck 106 and these components may be considered to be structurally significant components. Other structurally significant components may include the chuck carriage (not shown) which carries the chuck 106 and moves on a magnetic or vacuum-based air bearing system. Some or all of the structurally significant components may be formed from material that has a CTE which is substantially equal to the CTE of the intended substrate material. Structurally insignificant components are components whose expansion or contraction in response to temperature variations of about 1-2° C. above or below the base temperature in the context of UV curable imprint lithography will not effect the alignment of the substrate 108 and the patterned template 112. In the context of thermal imprint lithography, the temperature variation at the substrate chuck may be as high as 150° C. at the substrate chuck, and will decrease substantially with distance from the chuck. Structurally insignificant components may include, for example, the wiring, tubing, and magnets associated with the bearing system.

Turning to the imprint head, and although the present inventions are not limited to any particular type of imprint head, the exemplary imprint head 110 includes a number of components, some of which may be considered structurally significant. For example, and referring to FIG. 3, the exemplary imprint head 110 includes a main housing 110a, an orientation apparatus 110b that secures the patterned template 112 to the main housing and orients it relative to the main housing, and the various frame, guide and z-direction movement apparatus which are generally represented by reference numeral 110c. Some are all of these structurally significant components may be formed from material that has a CTE which is substantially equal to the CTE of the intended substrate material. Structurally insignificant components, i.e. those whose expansion or contraction in response to temperature variations of about 1-2° C. above or below the base temperature in the context of UV curable imprint lithography (and about 150° C. in the context of thermal imprint lithography) will not effect the substrate/template alignment, include, for example, wiring, mirrors, and thermal insulation between the main housing 110a and the radiation source 114.

With respect to the patterned template, and although the present inventions are not limited to any particular type of patterned template, the exemplary patterned template 112 is a unitary structure that is structurally significant. Glass is one example of a suitable template material and may be ordered from a glass manufacturer, such as Schott Glass located in Elmsford, N.Y., in a wide variety of CTEs. For example, the patterned template 112 may be formed from glass with a CTE that is substantially equal to silicon or gallium arsenide. Other suitable materials for the patterned template include, where practicable, the same material that is used to form the substrate. Regardless of the material employed, the patterned template should be at least partially transparent, i.e. transparent enough to allow UV radiation from the radiation source 114 to cure the curable liquid 126.

Alternatively, in those instances where a transparent substrate is employed and the radiation source is associated with the motion stage, the patterned template need not be at least partially transparent. As such, the patterned template may be formed from the same material as the intended substrate (e.g. silicon or gallium arsenide) in order to insure that the substrate and the patterned template have the same CTE.

Finally, with respect to the support apparatus, and although the present inventions are not limited to any particular type of support apparatus, the exemplary support apparatus 116 includes a bridge 118, a motion stage support 120, and a pair of bridge supports 122. Some are all of these structurally significant components may be formed from material that has a CTE which is substantially equal to the CTE of the intended substrate material. Structurally insignificant components on the support apparatus include, for example, the microscope.

As illustrated above, temperature related misalignment of the substrate 108 and the patterned template 112 may be avoided by forming the structurally significant components of the imprint lithography apparatus 100 that define the mechanical connection between substrate and the patterned template (“the substrate-patterned template mechanical connection”) from materials with a CTE that is substantially equal to the CTE of the intended substrate. Misalignment issues may be further mitigated by forming components of the imprint lithography system that are not part of the substrate-patterned template mechanical connection, including portions of the imprint lithography apparatus itself that are not part of the substrate-patterned template mechanical connection, from materials that are extremely thermally stable. As used herein, extremely thermally stable materials are materials that will exhibit essentially no expansion or contraction in response to temperature variations of up to about 150° C. above or below the base temperature. Suitable materials include Super Invar 32-5, an iron-nickel-cobalt alloy with a CTE of 0.63×10⁻⁶/° C., and Zerodur® machinable glass ceramic, which is available in CTEs that range from 0.00±0.02×10⁻⁶/° C. to 0.00±0.10×10⁻⁶/° C.

One example of a structure that is not part of the substrate-patterned template mechanical connection is the support table 200 which, in the exemplary embodiment illustrated in FIG. 1, is connected to the motion stage support 120 and bridge supports 122. The support table 200, which is formed from an extremely thermally stable material in the illustrated embodiment, is used to isolate the imprint lithography apparatus 100 from ambient vibrations. Other structures that may be formed from extremely thermally stable material include the frame for the microscope and the housing for the camera.

As illustrated for example in FIG. 9, one exemplary method of manufacturing an imprint lithography system includes the initial step of identifying the type of substrate on which the system will be forming patterned layers and determining the CTE of the substrate material (Step 1). Next, components of the imprint lithography system that may be associated with temperature related misalignment between the substrate and the patterned template are formed from material with substantially the same CTE as the substrate material (Step 2a). Some of the other components may be formed from materials that are extremely thermally stable (Step 2b). The imprint lithography apparatus may then be assembled (Step 3) and placed within a temperature controlled housing (Step 4).

Although the present inventions have been described in terms of the preferred embodiments above, numerous modifications and/or additions to the above-described preferred embodiments would be readily apparent to one skilled in the art. It is intended that the scope of the present inventions extend to all such modifications and/or additions.

We claim:

1. A system for forming a pattern in a material carried on a substrate, the substrate having a substrate coefficient of thermal expansion (“CTE”), the system comprising:
a motion stage configured to carry the substrate;
an imprint head configured to carry a patterned template in spaced relation to the motion stage; and
a support apparatus that mechanically connects the motion stage to the imprint head;
wherein a structurally significant component of at least one of the motion stage, the imprint head and the support apparatus has a CTE that is substantially equal to the substrate CTE.

2. A system as claimed in claim 1, wherein structurally significant components of each of the motion stage, the imprint head and the support apparatus have a CTE that is substantially equal to the substrate CTE.

3. A system as claimed in claim 1, wherein a structurally significant component of at least one of the motion stage, the imprint head and the support apparatus has a CTE that is substantially equal to the CTE of at least one of silicon, gallium arsenide and glass.

4. A system as claimed in claim 1, further comprising:
the patterned template.

5. A system as claimed in claim 4, wherein the patterned template has a CTE that is substantially the equal to the substrate CTE.

6. A system as claimed in claim 5, wherein
the patterned template is at least partially transparent; and
the imprint head includes a UV radiation source.

7. A system as claimed in claim 1, further comprising:
a support table formed from extremely thermally stable material to which the motion stage is secured.

8. A system as claimed in claim 1, wherein the structurally significant component comprises a motion stage base and a substrate chuck.

9. A system as claimed in claim 1, wherein the structurally significant component comprises an imprint head main housing and an imprint head template orientation apparatus.

10. An imprint lithography system for forming a pattern in a material carried on a substrate, the substrate having a substrate coefficient of thermal expansion (“CTE”), the system comprising:
a patterned template; and
a substrate-patterned template mechanical connection that mechanically connects the patterned template to the substrate;
wherein at least one of the patterned template and the substrate-patterned template mechanical connection has a CTE that is substantially equal to the substrate CTE.

11. An imprint lithography system as claimed in claim 10, wherein the patterned template and substrate-patterned template mechanical connection each have a CTE that is substantially equal to the substrate CTE.

12. An imprint lithography system as claimed in claim 10, wherein the substrate-patterned template mechanical connection comprises components of a motion stage, an imprint head and a support apparatus that mechanically connects the motion stage to the imprint head.

13. An imprint lithography system as claimed in claim 10, further comprising:
a radiation source configured to supply radiation to the material on the substrate.

14. An imprint lithography system as claimed in claim 10, further comprising:
a temperature controlled enclosure in which the patterned template and the substrate-patterned template mechanical connection are located.

15. An imprint lithography system as claimed in claim 10, further comprising:
a support table formed from an extremely thermally stable material to which the substrate-patterned template mechanical connection is secured.

16. A method of manufacturing an imprint lithography system, comprising the steps of:
determining the coefficient of thermal expansion (“CTE”) of a particular substrate material; and
forming one or more imprint lithography system components from material having a CTE that is substantially equal to the CTE of the substrate material.

17. A method as claimed in claim 16, wherein:
wherein the imprint lithography system includes a patterned template and a substrate-patterned template mechanical connection that mechanically connects the patterned template to the substrate; and
the forming step comprises forming the patterned template and substrate-patterned template mechanical connection from material having a CTE that is substantially equal to the CTE of the substrate material.

18. A method as claimed in claim 16, further comprising the step of:
forming components of the imprint lithography system that are not the patterned template or the substrate-patterned template mechanical connection from an extremely thermally stable material.

19. A method as claimed in claim 16, wherein:
the substrate material comprises silicon; and
the forming step comprises forming one or more imprint lithography system components from material having a CTE that is substantially equal to the CTE of silicon.
